(19) United States
(12) Patent Application Publication
(10) Pub. No.: US 2008/0058985 A1
(43) Pub. Date: Mar. 6, 2008

(54) Vending distribution system

(76) Inventor: Nicholas Alcov, Arroyo Grande, CA (US)

Correspondence Address: Nicholas Alcov, 2398 Callender Rd., Arroyo Grande, CA, 93420, US

(21) Appl. No.: 11/508,787

(22) Filed: Aug. 24, 2006

(51) Int. Cl. G06F 17/00

(52) U.S. Cl. 700/234

(57) ABSTRACT

A vending distribution system having an enclosure capable of housing a storage assembly containing a plurality of actual and sample items. Access to and controls for the storage assembly are separate from the access area thus creating a system with potential for two distinct areas. Interaction with the system determines the ability exclude items from vending without staff intervention thus providing usage for drive up unattended vending.

### FIELD OF THE INVENTION

The present invention generally relates to vending machines and more particularly to a vending distribution system. This system may be utilized to eliminate the necessity of having to wait to get the items being distributed. The system can be utilized for both items which need to be purchased as in the retail setting as well as prescriptions and supplies in the medical setting. The system can also be used by employers to distribute parts and assign tasks which can be ready for employees thus reducing waiting time. The system also allows sample items to be physically examined prior to vending the actual items.

### BACKGROUND OF THE INVENTION

In recent time, vending machines are widely used to dispense snacks and drinks and are just starting to be used to provide cameras, cell phones and similarly priced items. As vending machines are currently manufactured, limitation is inherent in the use of the vending machine for less traditional uses. Vending machines can provide a means to improve the distribution process, reduce error due to human factors such as repetitive handling and fatigue, as well as have items available, thus reducing waiting and frustration. This is particularly important in the medical setting where human lives are at stake. The vending distribution system can be utilized to distribute tools or parts in repair facilities and factories as well as many other productivity enhancing applications.

An automatic drug dispenser is described in U.S. Pat. No. 6,892,941 which details an elaborate and expensive system which ties computers into physicians writing prescriptions by computer, eye retina recognition and prescription entry systems together. While this may be conducive to large institutions a simpler and less expensive system may be needed for other purposes.

None of the prior art particularly teaches a system that reduced waiting time in a vending distribution system without the disadvantages as described above.

Accordingly, there is a need for a system which assists in the vending distribution of items in a simpler, cost effective manner.

### SUMMARY OF THE INVENTION

In view of the foregoing disadvantages inherent in the prior arts, the present invention provide vending distribution systems to reduce delays, reduce handling, thus reducing errors inherent in many distribution systems. The present invention also include the advantages of the prior art and overcome the drawbacks inherent therein.

In one aspect the present invention provides a vending distribution system where items are loaded from an area which is separated from the area where the items are retrieved. Back panels would allow access to load the machine. Controls to rotate or move the loading areas would be located at the loading area as well as at the retrieving area.

In another aspect, the present invention provides a vending distribution system where individual doors slide open to allow the loading of the items.

In another aspect of the present invention additional security is provided to the loading area of the vending distribution system. An lockable access door covers the loading area of the machine. Controls are made available to rotate or move the product spaces for loading of the items.

In another aspect of the present invention the vending distribution system incorporates a barcode or RFID system to regulate the distribution of the items contained therein.

In another aspect of the present invention the vending distribution system incorporates software to query the user about the item and about the user to determine if the item will be vended without the intervention of personnel.

In another aspect of the present invention, the vending machine has the ability to hold both sample as well as actual products.

In another aspect of the present invention, the vending distribution system incorporates software to query the user about the item and about the user to determine if the item will be vended without the intervention of personnel and is designed to accommodate usage through drive through windows.

### BRIEF DESCRIPTION OF THE DRAWINGS

FIG. 1 is a perspective view of the back of the vending distribution system illustrating panels providing access to the interior of the machine and controls and signal lights according to an exemplary embodiment of the present invention;

FIG. 1A is a perspective view of the front of the vending distribution system showing access and dispensing doors and controls according to an exemplary embodiment of the present invention.

FIG. 1B is a perspective view of the front of the vending distribution system showing a lockable access door suitable for stocking and maintenance According to a exemplary embodiment of the present invention.

FIG. 1C is a perspective view of the back of the vending distribution system illustrating the loading door for the loading area with controls to rotate the loading spaces and Identification slots, according to an exemplary embodiment of the present invention.

FIG. 2 is an exploded perspective view of the vending distribution system showing the retrieving doors, the internal carousel, and the enclosure according to an exemplary embodiment of the present invention;

FIG. 3 is a perspective view of a layer of a carousel of the vending distribution system illustrating sample items attached by securing means, followed by actual items according to an exemplary embodiment of the present invention;

FIG. 4 is a perspective view of a conveyor of the vending distribution system illustrating sample products followed by actual products, according to an exemplary embodiment of the present invention.

FIG. 5. is a flow chart depicting the process of the vending distribution system and displays for distributing medications.

FIG. 6 is a perspective view of a drive up window showing the retrieving door, display screen, interface buttons, and other features.

FIG. 7 is a summary of major steps for obtaining medications using the standard manual method versus the vending distribution system method.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular vending and distribution system, and a vending distribution system as shown and described. It is understood that various missions and substitutions of equivalents are contemplated as circumstances may suggest or render expedient, but the description is intended to cover the application or implementation without departing from the spirit or scope of the claims of the present invention.

The terms “first”, “second”, and the like, herein do not denote any order, quantity, or importance, but rather are used to distinguish one element from another. Further, the terms “a” and “an” therein to not denote a limitation of quantity, but rather denote the presence of at least one of the referenced item.

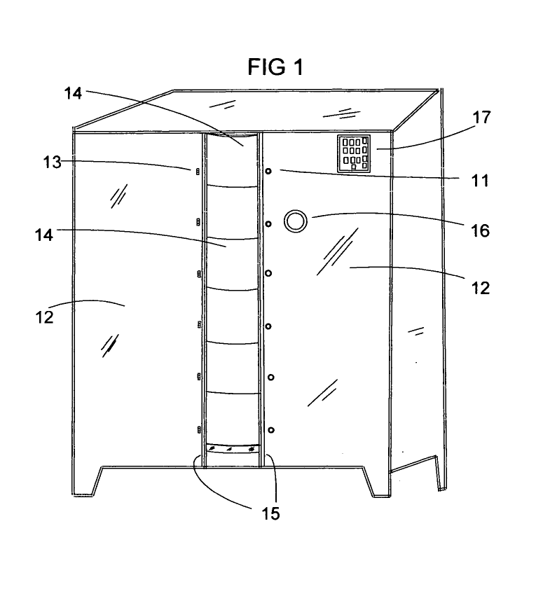

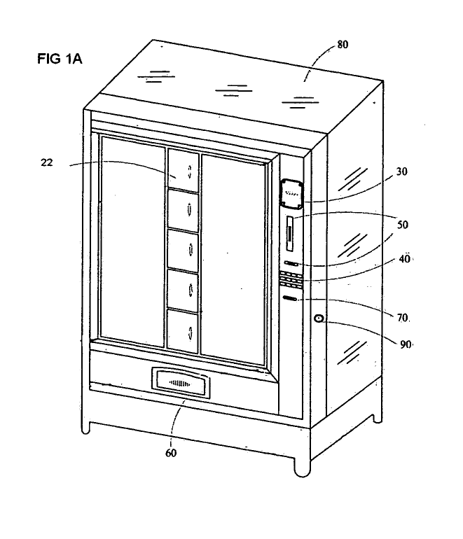

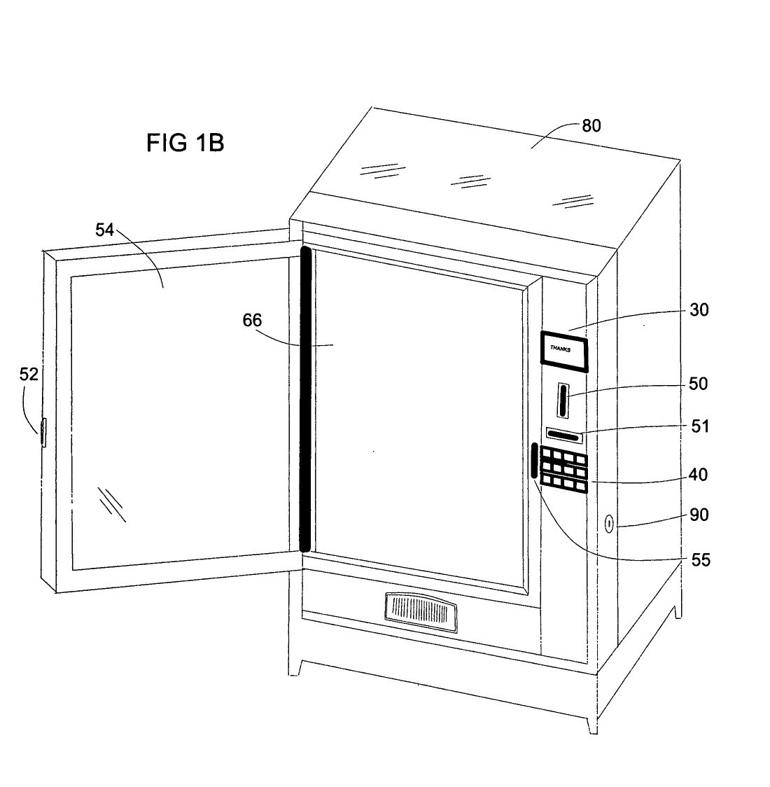

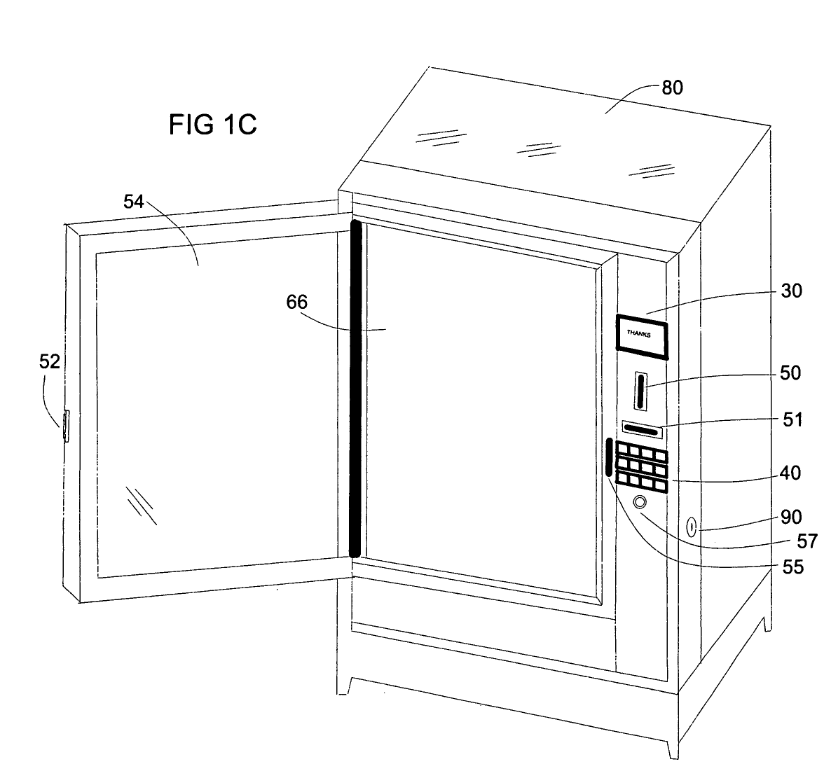

The present invention provides a vending distribution system to reduce waiting time, reduce employee handling, and thus reduce human error. Vending machines are traditionally thought of as providing snacks and drinks to consumers. A vending distribution system can be utilized in many retail as well as service and production work environments. In one example the tasks which an employee is assigned for the day determine the parts which will be needed. For example, a card with the first task for each employee is given to the parts department by the supervisor. The parts department stocks the vending machine with the parts required for each of the employee's first task along with the card with the assigned task. If the employer supplies specialty tools required for the task, these could also be loaded with the parts. Access to load the vending machine FIG. 1 is made easier through the back where the back panels 12 allow access to the bins 14 but not to the wiring or other areas which could cause cuts and electrical shocks. The number of bins and access doors is exemplary only and may vary as needed. Generally the number of layers of a carousel or the number of conveyors will compliment the number of access doors. These items can be waiting as the workers arrive. As the morning tasks are being preformed, the parts department can be stocking the vending machine with the parts required for the next set of tasks. The edge of the back panels 12 would have a means of preventing cuts such as putting a roll in the edge of the panels, polishing them, covering the edge with a material such as a plastic or rubber gasket 15 or the like. To prevent injuries, an over ride switch 16 would prevent the front user from access or the ability to rotate the compartments if the machine is being stocked. A warning light or alarm could also warn that the machine is in use. Inter face buttons 17 may or may not be needed depending on the needs of the user.

FIGS. 1A and 1B illustrates the front of the vending distribution systems comprising an enclosure 80 housing a storage assembly 66. The storage assembly 66 is capable of storing a plurality of items (not shown) to be vended through the vending distribution system. Access to the front of the vending machine FIG. 1A could be restricted if needed by requiring an employee to utilize his badge or identification card in the reader 50. Authentication by entry of a personal identification number, PIN, with the user inter face buttons 40, or a systems utilizing sensor technology (not shown) able to read an identification or credit card by passing it near the sensor can be included if desired, are some of the possible means of authentication. The items stored in bins 310 can be accessed through doors 312 for carousel style vending machines or vended into the product dispenser 60 for other vending machines which utilize helical spring or other means for dispensing, once the inter face buttons of the input device 40 are pressed. The vending distribution system used for retail transactions may need a display screen 30 and a printing outlet 70 for a receipt. FIG. 1B illustrates a locking mechanism 52 which engages with a complimentary portion 55 on the enclosure 80 A lock 90, allows access to the storage assembly 66 by opening the vending machine door 54 for stocking or general maintenance. The vending distribution system can be utilized in pharmacies, laboratories, hospitals, automobile service centers, assembly lines and the like.

In another embodiment as illustrated in FIG. 1C a stocking and maintenance door 54 is provided at the back of the vending machine. Access is provided by a lock 90 which engages the locking mechanism 52 in a complimentary portion 55 on the enclosure 80. A means to move the carousel, conveyor or other vending means is provided by a button or plurality of buttons 40. The display screen 30 and reader slot 50 may or may not be required for this back side of the vending machine depending on the requirements of the facility. With the loading and maintenance door on the back of the vending machine, the front of the vending distribution system may not need such a door and as such would not have the lock, locking mechanism and its complimentary portion. A over ride switch 57 would prevent access at the front of the machine while the loading area is being utilized. The other features for the front of the vending distribution system as described in FIG. 1A would still pertain.

In another embodiment of the invention, the vending machine will have a signal such as a light 91 next to each bin door to indicate that the items are ready for pick up as shown in FIG. 1A. If the part is damaged, defective or the wrong part was loaded, a card with the problem checked can be loaded into the vending machine with the problem part after the employee swipes his employee badge. The employee can push a button which causes a warning light on the parts department side to light up. The same light 91 can have a dual function with a connection to a switch which activates when pushed.

In another embodiment of the invention a scanner will read the barcode or RFID label on the problem part and a indicator light 11 of FIG. 1, on the parts department side will light up when the item is put back into the bin. A single button can cause the entire drum to rotate or in the more complex version a button 13 can rotate each layer individually. Items are deleted when they are removed from the vending machine. This can be tied into an inventory management system which creates a re-order list when items drop to a specified level. Since the items are in the vending distribution system, time spent by the employee waiting for the parts department to pull the parts that he needs is reduced. It also reduces theft of inventory since the barcode or RFID reader records the usage of parts, and by whom. Abnormal activity is easier to spot if the same employee has an abnormal amount of faulty, broken parts and the like.

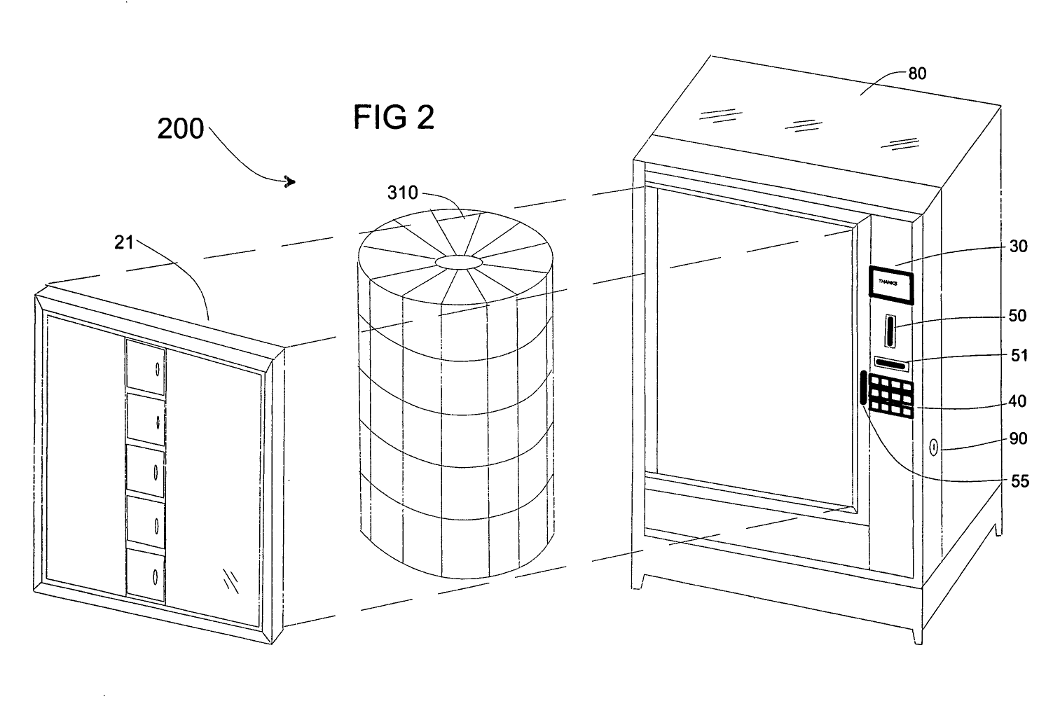

In another embodiment of the invention, the back of the vending distribution system 200 is shown in FIG. 2 having access doors 21 for stocking the vending machine carousel 310 or conveyors (not shown). The access doors 21 are activated by an employee badge or identification card through reader 50. Access doors similar to 21 to pick up the parts or medications. would be on the front side of the machine. In a simpler version the display screen 30 may not be needed. Inter face buttons 40 for functions such as rotating the carousel are shown. This type of machine can be utilized when additional security is required. The machine could be placed in a less utilized doorway which separates the stocking area from the access area. or a wall or partition around the vending machine could provide separation of the two areas. The machine could keep track of which employees have accessed the machine and at what time.

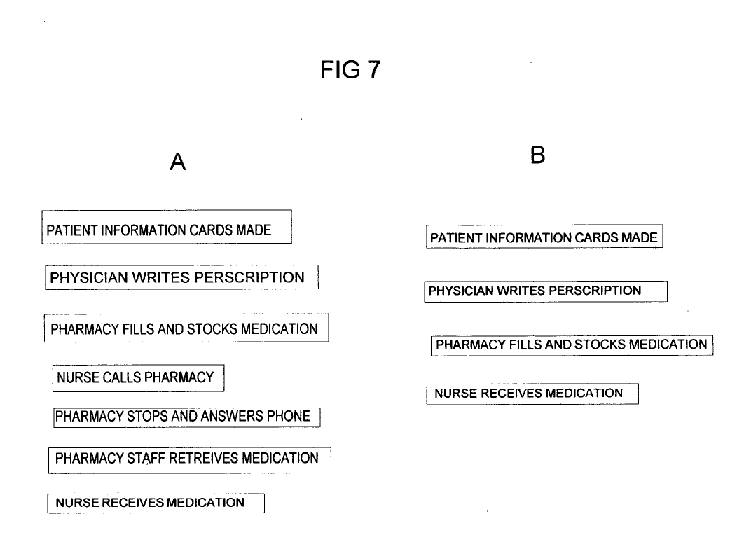

The vending distribution system can be used in medical centers where a patient Identification card and wrist band with a barcode or RFID label on it could be made in admitting or each department can make their own. Stickers, embossing name plates and/or the like may provide other means of patient identification and control. Departments such as Laboratory, pharmacy, the nursing office and others will have these barcode or RFID plates. Heavy use centers such as nursing can get two RFID plates. One is kept at the nursing station and the other is kept with the chart. A vending machine such as the carousel type could be used in areas such as pharmacy, laboratory and the supply center. For example when pharmacy gets a prescription written by a physician, the pharmacist puts the pills in a plastic tube or bag with the barcode or RFID labeled information on it. In one embodiment, the pharmacy tech or the pharmacist will need to swipe his employee badge to gain access to the vending machine. When the scanner reads the barcode or RFID label, the information is stored in the micro processor with the patients name. When the nurse is ready to pick up the pills for the patient, she takes the patient information card from the chart, goes to the pharmacy, swipes her employee badge and then swipes the patient information card. The vending machine will rotate to the proper position for that patient and open the vending door to allow the nurse to get the pills. This will eliminate the wait to get medications because a pharmacy tech is on break, at lunch, or called in sick. A vending machine with the ability to be accessed remotely to determine if the pills are in the vending machine is also an option. This will eliminate the time wasted by nurses calling the pharmacy to see if the medications are ready for their patient. Currently, with manual systems, a technician places the medications alphabetically by patient last name in an area for pick up. Then there is the additional step of the pharmacy technician having to get the medication when the nurse or patient arrives for pick up. This is the step which is eliminated by the vending distribution system, thereby reducing mistakes resulting from the additional handling and human error. The system can be programmed so that patients with more that one medication can have them loaded into the same location. The system can be programmed to warn of duplicate medications FIG. 7 shows a representation of the steps used in a manual method A and method B utilizing the vending distribution system with fewer steps. The savings in time, reduction from human errors, reduced frustrations, would be multiplied by each department utilizing the vending distribution system.

In another embodiment, as shown in FIG. 1A, the patient name is displayed on a screen 30 and the nurse would utilizing the inter face buttons 40 for the name to appear on the screen. Once the correct name is selected and the vend button pressed, in some vending machines, the medication will be vended to the product dispenser 60. In other types of vending machines an access door 22 will open allowing the item to be retrieved.

In another embodiment of the vending distribution system the inter face buttons would be utilized to have the vending machine bring the items to the appropriate vending position by punching in the last and first names, telephone number and whatever required information is programmed into a micro-chip. The buttons could be arranged as they appear on a telephone (not shown) where keys represent both numbers as well as letters. Since we are all becoming familiar with this configuration, it would reduce the number of inter face buttons required.

In the laboratory a similar vending distribution system can be utilized for specimen and result handling. As an example the bottom portion of the vending distribution system can be utilized to hold specimens. And the top portion can be utilized to hold lab results. The vending machine can be set up so that the bins are stocked, by floor, department, patient last name or the like. Security would be provided through use of the identifications authorization slots described above or entry of a PIN number by the inter face buttons.

In the more complex version, a barcode or RFID scanner inputs information from a lab request form which is scanned along with the labeled specimen. The vending machine is programmed to allocate the space where the specimen and lab request are loaded into the vending machine. The laboratory could select and label certain spaces in the vending distribution system for “stat” tests, or the vending machine could be programmed to allocate spaces for priority test, I.e. “stats” or simply rotate to those “stats” when the appropriate inter face button on the vending machine is pressed. Vending distribution systems which utilize a display screen can show patient names and the tests requested for “stat” orders by reading the barcode or RFID labels on the specimen when the nurse or lab technician loads the vending machine. The vending machine and/or the scanner can be interfaced to the lab computer to create a patient list of the tests to be done and have it ready for the laboratory technologist to process. Similarly the lab results with the patient barcode or RFID label on it is scanned and loaded into the vending machine. The floor nurse can pick up results when she drops off the specimen. Once again a processing step is eliminated reducing human handling and human error. Less time is spent waiting by nursing staff and lab personnel looking for the results. There would be less time wasted with phone calls to see if lab results are ready. While the above example pertains to a health care setting, a similar system can be utilized for multi departmental distributions such as manufacturing, research and development and the like. For example an aircraft manufacturer can utilize the system with the model of the plane determining how the machine is stocked. For example, several models may utilize the same type of switch. The system would allocate that the switch is assigned to a specific department with a specific part number thus keeping track of employees, parts and the airplane model in the event of part failure, for restocking or other needs.

In another embodiment of the present invention, the barcode/RFID system can aid in keeping track of billing for supplies, prescriptions and the like.

In another embodiment of the present invention, contact less technology could be implemented where the employee identification card and patient card describes previously only need to be passed near the sensor to function.

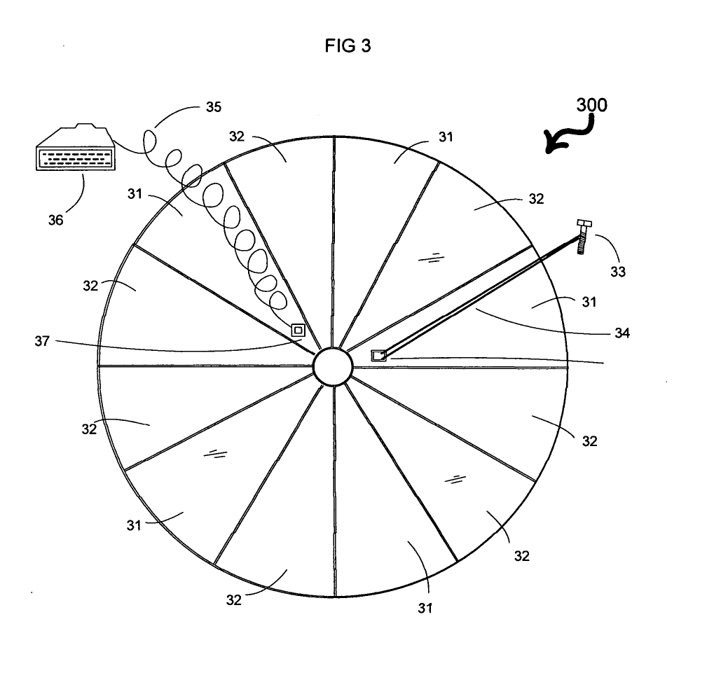

In another embodiment of the present invention, the vending distribution system may be utilized by an employer who may have company tools which the employees need to use. The carousel or conveyor are some but not the only type of vending machines which may be especially useful for this distribution. This is especially true when there are only one or a few of each type of tool, and when the employee may need to physically examine the tool. For example a 12 mm bolt has broken off and the broken piece needs to be extracted with a tool which the employer provides. There are three different thread coarsenesses and the employee needs to physically compare the extracting tool to the threads of the broken piece which is out. Within the vending distribution system, a storage assembly contains a carousel, conveyor or other means to house the items. The number of these carousels or conveyors would vary with the size of the vending machine needed and the number of items required. FIG. 3 shows one layer of a carousel 300 where securing mechanism 37 retains a sample in space 31, which is preceding space 32, which holds the actual tool. In this example a 12 mm bolt 33 with the correct coarseness could go into sample space 31. Or a worn out extracting tool suitable to show the coarsens can be utilized for the sample. This system is beneficial when the employer wants to keep track of which employees are using which tools, but the vending machine does not have the option of allowing the employee of returning the tool to the space it came from once it is vended. Glue, solder, weld, rivet, or other suitable means could be used to attach the sample item to a retractable cord 34, coiled spring 35 or the like which is attached to the securing mechanism. The securing mechanism 37 is attached to the carousel by means of glue, rivet, bolt or other means to assure the sample gets returned to its proper place in the vending machine. Other items could go in the sample space. For example an employee may need to compare the configuration of the electrical connectors for a part or tool, the sample space may house a card with a drawing of the connector pattern, or a worn out part 36 which shows the connector pattern. The example described should not be limiting as this aspect of the vending distribution system can be utilized for the retail sector as well as the work sector and for different vended items than those described.

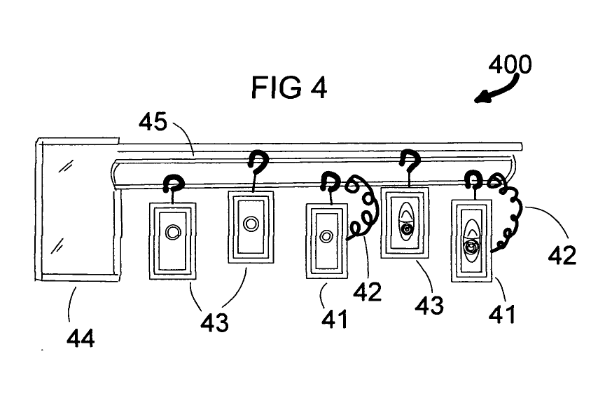

The vending distribution system improves the typical conveyor type vending machine in that traditionally the conveyor would not permit physically examining the item prior to vending. Generally there are a plurality of conveyors, housing a plurality of items. A conveyor 400 is displayed in FIG. 4 where a display sample 41 held by means of a retractable attachment 42, such as a coil spring, a retractable cord, elastic or the like, which can not be removed from the conveyor. The retractable attachment 42 is attached to the sample by glue, weld, rivet, tie down or other suitable means, The sample item can be physically examined prior to removing the actual product 43 which follows the sample position as the motor 44 moves the conveyor 45. An additional benefit to this system is that different item may be housed on the same conveyor.

In another embodiment, the vending distribution system may have a scanner capable of tracking when an incorrectly chosen item is returned to its space. The barcode or RFID label is read and the item deducted from stock If the item is returned to the vending machine, the scanner would add the item back to stock. In a more complex version, the employee who accessed the vending distribution system would be assigned to the item taken with the results stored in a microchip. The results could be downloaded to a computer or programmed to be printed from the printer outlet 70, as shown in FIG. 1A.

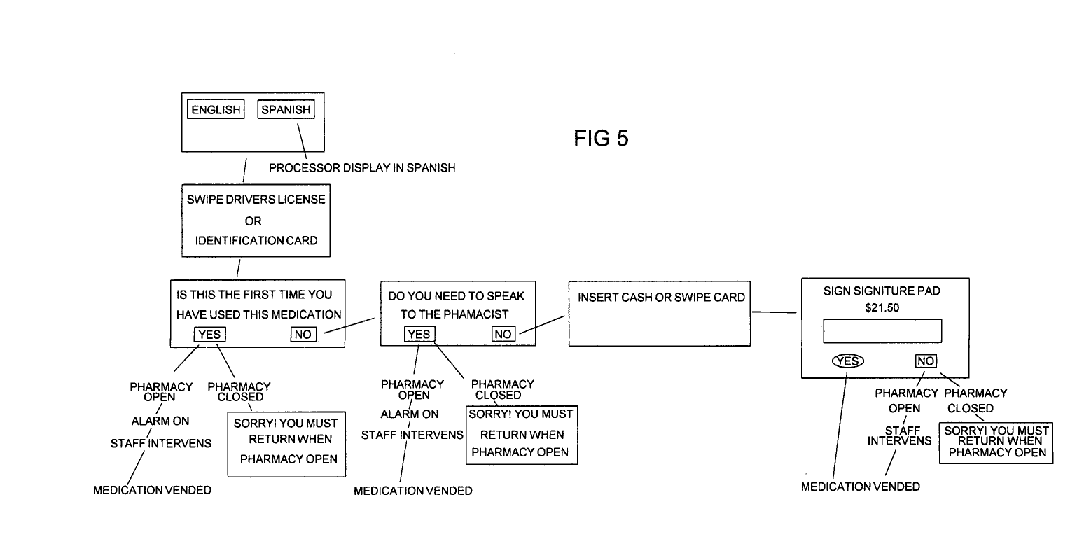

While the examples illustrate vending distribution systems in non retail settings, the same principles could apply with vending machines which accept cash through payment slots 51 of FIG. 1B, credit cards through reader 50 or the contact less payment systems (not shown) which are becoming popular. For example, the vending distribution system can be utilized in retail pharmacies. The vending distribution system stocked with medications in the carousels, conveyors, or the like in the storage compartment 66, could be programmed to display questions as in the example in FIG. 5. These questions can be on the display screen, on the signature pad or other means. For example, after the display screen 30 asks the customer to choose English or Spanish, it displays, “Is this the first time you are using this medication?” or similar verbiage with a YES or NO touch display appearing on the display screen. Before the machine would proceed any further the customer would have to touch YES or NO on the display, or the buttons corresponding to the YES or NO response in the touch pad 40 or respond by voice or other integrated means. If YES is touched, a warning such as a flashing light or alarm would alert the pharmacy that someone would need to speak to the customer. At this point the technician may want to ask the rest of the questions to allow the machine to vend the item. Or allow it to proceed with the queries. Appropriate interface buttons would be needed on the pharmacy side of the machine. If NO is touched the program would proceed to the next question of “Do you need to speak with the pharmacist?” A YES or NO would again be displayed on the screen. If the YES is touched, a warning would again alert the pharmacy to deal with the situation. The machine could be tied into the computer system which contains insurance or other discounts. The amount would be displayed on the screen with the OK or NO displayed on the screen. IF NO is touched a warning would alert the pharmacy. If OK is touched, The screen would indicate with a phrase such as “Insert cash or swipe card.” The queries described are examples and should not be limiting as others may need to be incorporated. A separate signature pad (not shown) where credit cards are swiped could be utilized to display the queries and YES or NO responses in place of the display screen if more convenient. Computer generated voice interaction is becoming prevalent and can be incorporated if appropriate. Once the medications are paid for the carousel or conveyor would rotate to the appropriate position and the package would be vended or the door would open allowing the customer to take the medications. The machine could be stocked so that the items are grouped alphabetical by customer last name by the number of door or layer which are in the vending machine. For example last names starting with A through F would be in the first layer of the carousel or on the first conveyor and if the machine has a door, it would be vended through the first door. Similar grouping would be arranged with the rest of the names.

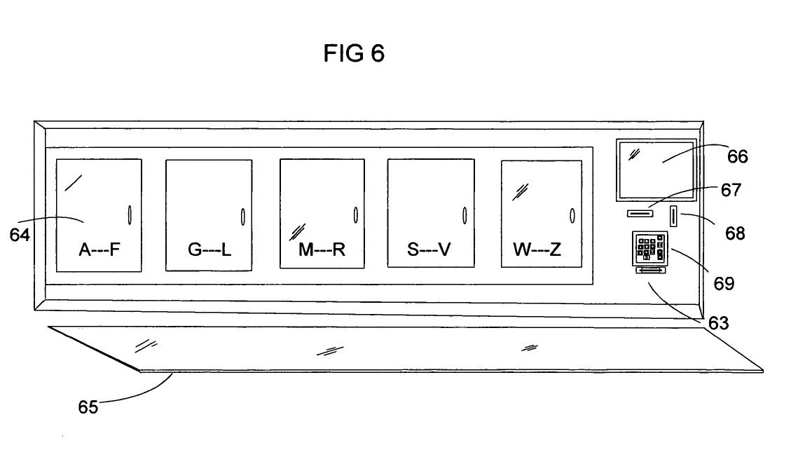

A similar program with similar questions would be useful for the pharmacy drive up window. However because the working space available to a driver is limited, the vending machine could be designed to vend the items which would be dispensed to the drive up window tray. A means such as a chute, trough, tube or the like could be utilized. A vertical carousel type machine can also be utilized and stocked alphabetically by last name into groups determined by the number of doors the machine has. FIG. 6 shows an example of what a driver would see. The vending distribution system could be located next to the traditional drive up window we are familiar with. The number of doors 64 of FIG. 6 would need to accommodate a person's reach from a car window. If required, a fold down tray 65 at the drive up, attached to the building or part of the machine would deter vandalism. The printer outlet 63, authentication slot 68 for reading the credit card and drivers license, cash slot 67, and interface buttons 68 and doors 64 would need to be reached through a cut out in the building. The vending distribution system could be made to slide up against a cut out made in the building, or the cut out could fit the existing configuration of the vending distribution system. A display 66 could be a touch screen for easier use and the queries described in FIG. 5 could be shown there. Another option would be to have the display screen, interface buttons, credit card terminal attached to the fold down tray for easier reach. The controls and items described in FIG. 1 and FIG. 1C on the back of the vending distribution system could stay the same with the exception that in the vertical carousel the bins and doors would be aligned vertically and inter face buttons would be needed on the stocking side for the staff to inter act with the machine when staff intervention is needed.

Many pharmacies are now utilizing a automated phone system for refilling prescriptions. The questions required to allow vending of the medications could be incorporated into the phone queries. If the questions are answered so that the medications can be dispensed without the need of pharmacy staff, the vending machine could be utilized to pick up medications both in the store which may stay open after the pharmacy closes or in the drive through vending distribution system, 24 hour a day. Dispensing problem which occur after hours could be saved in the processor and the staff alerted when the pharmacy re-opens. The information pertaining to the problem such as customer name, medication, and what the problem is, could be incorporated into the printout which the store retains for its credit card transactions, on the display screen or by other means. The pharmacy could decide to block the customer from further attempts to obtain the medication after hours if the questions require staff intervention. They could allow the customer to get the medication if there was a cost difference and have the customer come in when the pharmacy is open to get a price adjustment.

While the example pertains to a pharmacy, it should not be limiting as the same principles would have other applications for both retail purchases as well as non retail item distribution.

The forgoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstances may suggest or render expedient, but is intended to cover the application or implementation without department from the spirit or scope of the claims of the present invention.

What is claimed is:

1. A vending distribution system, comprising;
An enclosure capable of housing a storage assembly, the storage assembly capable of storing a plurality of actual items, said storage assembly also capable of storing a plurality of sample items, the sample item capable of being examined by a user on accessing the vending distribution system to determine if said actual item, is indeed the desired item, having a means to deter the theft of said sample item, and a means of retrieving said actual item.

2. A vending distribution system of claim 1, wherein the storage assembly further comprises a securing mechanism for holding said sample item on to said storage assembly.

3. A vending distribution system of claim 1, wherein the securing mechanism is an extendable apparatus selected from a group consisting of springs, coils, retraceable cords, elastic cords and the like.

4. A vending distribution system of claim 1, wherein a portion of the front of the enclosure has a reader capable of determining identification for access to the items.

5. A vending distribution system of claim 1, wherein the remaining portion of the front of the enclosure has an input device with a plurality of user interface features for selection of products, interacting with the information in the display screen, entry of authentication PIN numbers, manipulating the vending mechanisms, dispensing the product and the like.

6. A vending distribution system of claim 1, wherein a barcode or RFID scanner monitor the items in the storage assembly.

7. A vending distribution system of claim 1, wherein the item desired may be vended by entering information with user interface buttons. swiping a driver license and/or other authentication source.

8. A vending distribution system of claim 1. wherein the item desired may be vended by user inter face of information displayed on a display screen and/or inter face buttons.

9. A vending distribution system of claim 1, wherein a soft ware program is integrated to query the user to determine if vending can occur without intervention by personnel.

10. A vending distribution system of claim 1, wherein a means is provided to obtain information on if a specific item is stocked and the information can be accessed from a remote location.

11. A vending distribution system, comprising;
a storage assembly capable of storing a plurality of items;
an access section disposed on a side of the storage assembly, preferably the front side, the access section capable of storing and providing access to or display of a plurality of items; an enclosure capable of housing the storage assembly and the access section; and an authentication mechanism capable of authenticating a user prior to accessing the items, a stocking section disposed on a different side of the storage assembly, the stocking section having control buttons to move the positions of the storage assembly for stocking and a means of preventing access or control by the access section when the stocking section is in use.

12. A vending distribution system of claim 11, wherein access to the stocking section is limited by means of doors, an authentication system, a locking mechanism and/or the like.

13. A vending distribution system of claim 11, wherein a barcode or RFID scanner monitors the items in the storage assembly.

14. A vending distribution system of claim 11, wherein a items can be accessed through user interaction with the vending distribution system by means of a card reader, a display screen, user interaction buttons, audible interaction, and/or the like.

15. A vending distribution system of claim 11, wherein a software program is integrated to query the user to determine if vending can occur without intervention by personnel.

16. A vending distribution system of claim 11, wherein the access section is integrated for use with a drive up window.

17. A vending distribution system of claim 11, wherein a barcode or RFID label is integrated with the vending distribution system to regulate that the items dispensed are the items required by means of the card reader, display screen, user interface buttons, voice integration and/or the like.

18. A vending distribution system of claim 11, wherein a microchip retains information capable of being downloaded and/or printed.

19. A vending distribution system of claim 11, wherein the item desired may be vended by entering information with user inter face buttons, swiping a drivers license and/or other identification sources.

20. A vending distribution system of claim 11, wherein the item desired may be vended by user inter face of information displayed on a display screen and/or user inter face buttons.

21. A vending distribution system of claim 11, wherein a means is provided to obtain information on if a specific item is stocked and that information can be accessed from a remote location.
